(19) United States
(12) Patent Application Publication
(10) Pub. No.: US 2008/0099212 A1
(43) Pub. Date: May 1, 2008

(54) Modified Fire Fighting Truck

(76) Inventor: Ted-Xuan Do, Bronx, NY (US)

Correspondence Address: WILSON DANIEL SWAYZE, JR., 3804 CLEARWATER CT., PLANO, TX, 75025, US

(21) Appl. No.: 11/549,992

(22) Filed: Oct. 17, 2006

(51) Int. Cl. A62C 27/00

(52) U.S. Cl. 169/24; 169/70; 239/165; 239/251; 239/225.1

(57) ABSTRACT

A firefighting system for use on a firefighting truck includes a telescoping support frame, a telescoping arm connected to the telescoping support frame, a water pipe extension to extend the telescoping arm, and a spinning nozzle positioned at an end of the water pipe extension.

### FIELD OF THE INVENTION

The present invention relates to a fire fighting equipment including a spray head with a number of nozzles.

### BACKGROUND

Fire fighting systems have utilized numerous methods to extinguish fires. The economic waste caused by fire demands continuous improvement in fire fighting means. An effort to develop efficient and economical fire fighting equipment has spawned extensive research and experimentation to improve techniques and equipment. Prior to the making of this invention, fire fighting systems ranged from bucket brigades to the application of sophisticated chemical agents, each having its own limitations. Many fires have raged unchecked because inefficient use of available water and chemical fire retardants are expensive.

### SUMMARY

The object of the invention is to provide new fire fighting equipment, which is more effective than prior art equipments.

A firefighting system for use on a firefighting truck includes a telescoping support frame, a telescoping arm connected to the telescoping support frame, a water pipe extension to extend the telescoping arm, and a spinning nozzle positioned at an end of the water pipe extension.

The firefighting system includes a male adapter positioned at an end of the water pipe extension.

The firefighting system includes a female adapter positioned at an end of the telescoping arm.

The female adapter may be coupled to the male adapter.

The first spinning nozzle may be positioned substantially perpendicular to said water pipe extension.

The firefighting system includes a second spinning nozzle positioned opposed to the first spinning nozzle.

The firefighting system includes a rotatable base connected to the telescoping support frame.

The telescoping support frame may be connected to a first pneumatic lifter.

The telescoping arm may be connected to second pneumatic lifter.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates the firefighting system in accordance with the present invention;

FIG. 2 illustrates another view of the firefighting system in accordance with the present invention;

FIG. 3 illustrates a view of the water pipe extension of the present invention.

FIG. 4 illustrates the use of the present invention.

### DETAILED DESCRIPTION

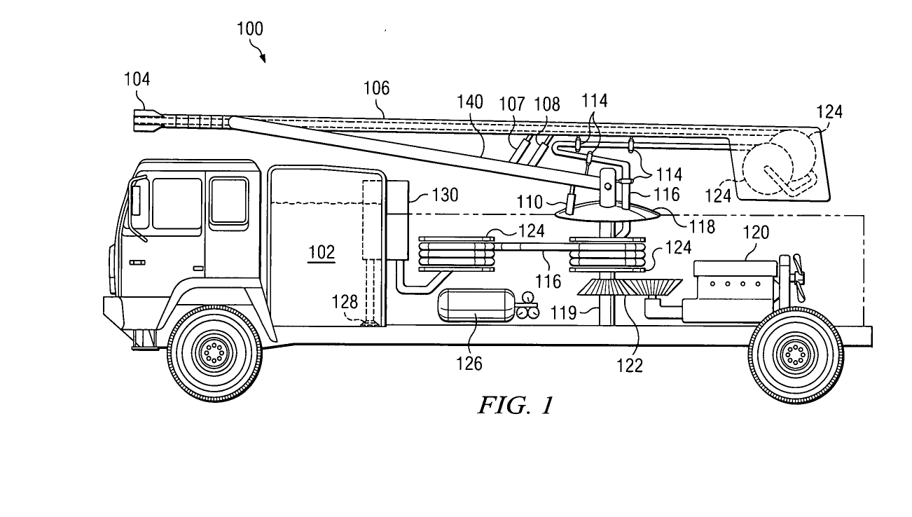

FIG. 1 illustrates a firefighting system 100 in accordance with the teachings of the present invention. The firefighting system 100 may include four main parts. The first part includes the fire truck; the second part includes a telescoping support frame; the third part includes a telescoping arm; and the fourth part includes a water pipe extension which may be attached by male and female adapters at the end of the telescoping arm.

The fire fighting system 100 includes a water tank 102 which allows water to be stored for use with the firefighting system 100. Additionally, the firefighting system 100 includes a female adapter 104 which is connected to the telescoping arm 106 to allow different spray heads to be attached to the telescoping arm 106. The firefighting system 100 includes a first pneumatic lifter 107 to lift the telescoping arm 106, a second pneumatic lifter 108 to additionally lift telescoping arm 106, and a third pneumatic lifter 110 to lift the telescoping support frame 140.

The telescoping support frame 140 can rotate by a rotatable base 118 which is connected to the third pneumatic lifter 110. The rotatable base 118 is connected to a shaft 119 which is connected to gears 122 to rotate the shaft 119. The gears 122 are connected to an engine 120 to rotate the gears 122 which in turn rotates the shaft 119, the rotatable base 118 and the telescoping support frame 140. The water tank 102 supplies water for the hose 116 and eventually for the spray heads. The hose 116 could be wound around the retractable hose reels 124 which are positioned beneath the rotatable base 118 and also at the proximate end of the telescoping arm 106. The hose 116 is guided along ball bearings 114 placed along the telescoping support frame 140 and the telescoping arm 106. At the bottom of the water tank 102 is positioned a filter 128 to filter the water before it enters the water pump 130 which supplies the hose 116 with water.

The distal end of the telescoping support frame 140 is pivotably connected to the telescoping arm 106. The telescoping arm 106 is pivoted with respect to the telescope support frame 140 by the first pneumatic lifter 107 and the second pneumatic lifter 108. The proximate end of the telescoping arm 106 includes a reel 124 for the retractable hose. The telescoping arm 106 extends the hose 116 to the location of the fire.

The functions of the first pneumatic lifter 107, the second pneumatic lifter 108 and third pneumatic lifter 110 are to fold and raise the telescoping arm 106.

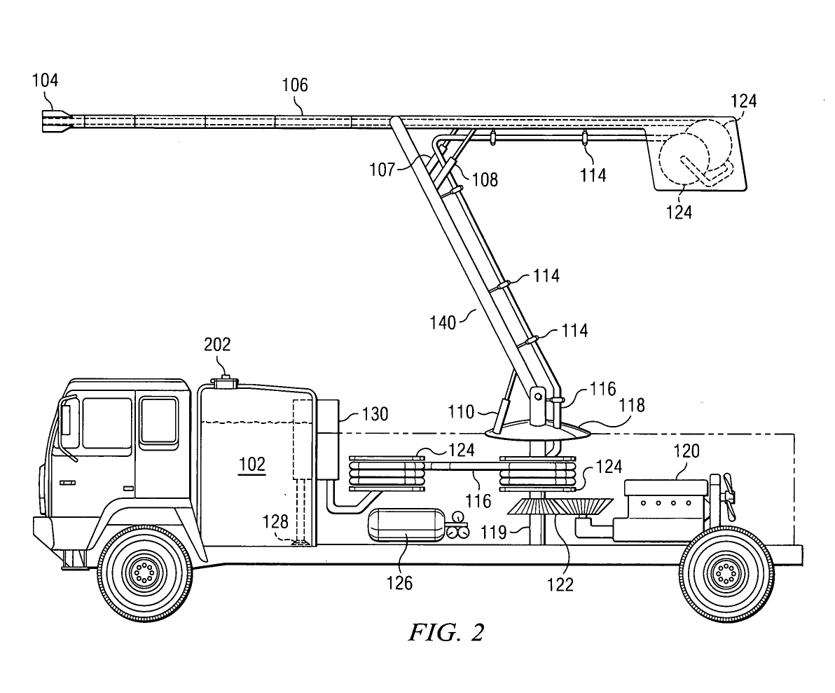

FIG. 2 illustrates that the first pneumatic lifter 107, the second pneumatic lifter 108 and the third pneumatic lifter 110 have lifted the telescoping arm 106 up into the air in a substantially horizontal position. The telescoping support arm 140 has been extended to lift the telescoping arm 106. FIG. 2 additionally shows the refill valve 202 to allow the water tank 102 to be refilled.

The retractable hose reel 124 has one end of the hose 116 fixed to the water pump 130, and the other end of the hose 116 can be extended to reach the the tip of the female adapter 104.

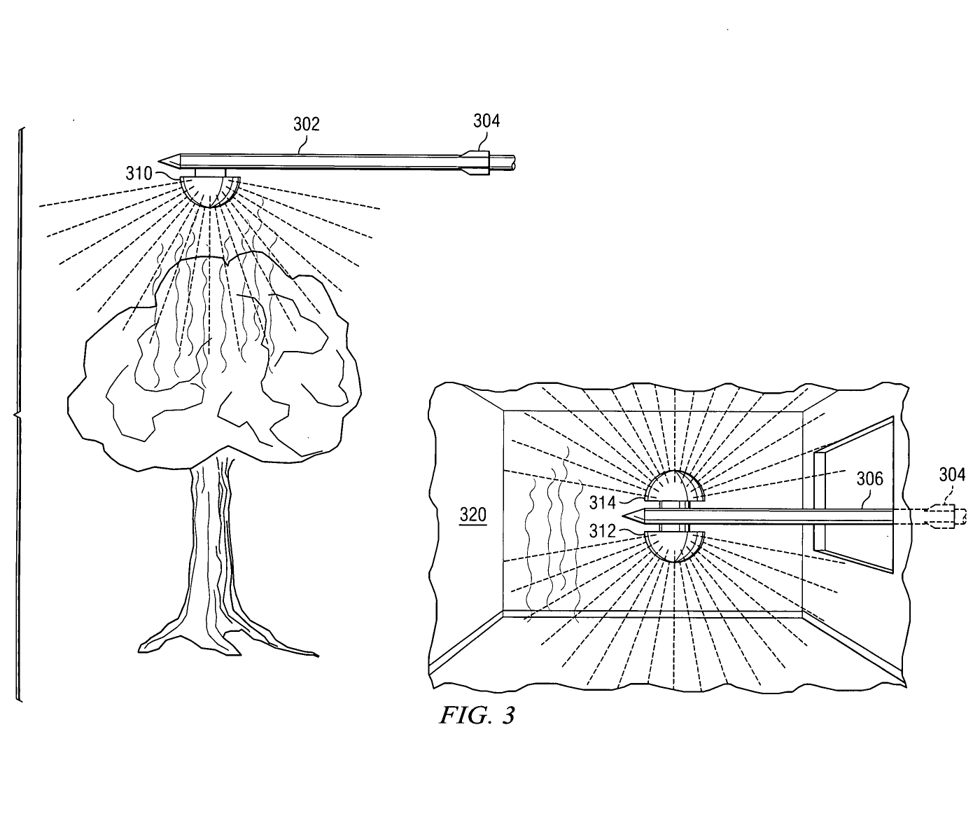

FIG. 3 illustrates a first water pipe extension 302 which extends the telescoping arm 106 and which is connected to the telescoping arm 106 by the connection of the male adapter 304 to the female adapter 104. The proximate end of the water pipe extension 302 includes the male adapter 304 while the distal end of the water pipe extension 302 includes a single spinning nozzle 310 which is positioned approximately perpendicular to the water pipe extension 302. The single spinning nozzle 310 is useful for grass and brush fires because the single spinning nozzle 310 can be directed downwards.

FIG. 3 additionally illustrates a second water pipe extension 306 which includes the male adapter 304 at the proximate end of the water pipe extension 306. The distal end of the water pipe extension 306 includes a first spinning nozzle 312 and an opposed second spinning nozzle 314. The water pipe extension 306 may be inserted through a window of a building 320, and the first spinning nozzle 312 and the second spinning nozzle 314 discharge water in all directions so that the entire room of the building 320 receives the discharging water.

The first spinning nozzle 312 or spray head and the second spinning nozzle 314 or spray head are shaped like the Northern and Southern Hemispheres. The advantage of the water pipe extension 302, 306 is that it extends the reach of water to a longer distance. The water pipe extension 302, 306 may be any length and could be the length of the fire truck. The advantage of the spinning nozzle 312,314 is that it spreads water over a larger area. The firefighting system 100 of the present invention has additional uses other than fighting fire. For example, the firefighting system 100 could be used to water a farm during dry season.

The air compressor 126 is connected to the first pneumatic lifter 107, the second pneumatic lifter 108 and the third pneumatic lifter 110 to provide the lift for each lifter 107, 108, 110.

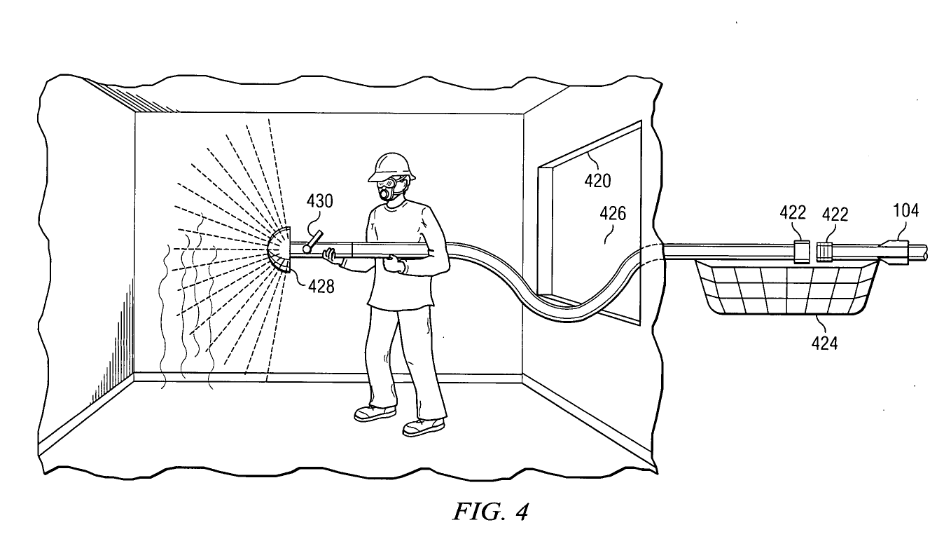

FIG. 4 illustrates a fireman using an embodiment of the present invention. FIG. 4 shows that the male adapter 104 is adjacent to a cage 424 which can be used to rescue people trapped a burning building and for the fireman to enter through a window 420 to fight the fire. Water hose connectors 422 are connected to a flexible hose 426 so that the firemen can spray water into the room. The firemen controls the flow of water with a water controller 430 which controls the flow of water to the hemisphere nozzle assembly 428 which includes nozzles which face at different angles with respect to each other so that four sides of the room can be reached by the water.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A firefighting system for use on a firefighting truck, comprising:
a telescoping support frame;
a telescoping arm connected to said telescoping support frame;
a water pipe extension to extend said telescoping arm; and
a first spinning nozzle positioned at an end of said water pipe extension.

2) A firefighting system for use on a firefighting truck as in claim 1, wherein said firefighting system includes a male adapter positioned at an end of said water pipe extension.

3) A firefighting system for use on a firefighting truck as in claim 2, wherein said firefighting system includes a female adapter positioned at an end of said telescoping arm.

4) A firefighting system for use on a firefighting truck as in claim 3, wherein said female adapter is coupled to said male adapter.

5) A firefighting system for use on a firefighting truck as in claim 1, wherein said first spinning nozzle is positioned substantially perpendicular to said water pipe extension.

6) A firefighting system for use on a firefighting truck as in claim 1, wherein said firefighting system includes a second spinning nozzle positioned opposed to said first spinning nozzle.

7) A firefighting system for use on a firefighting truck as in claim 1, wherein said firefighting system includes a rotatable base connected to said telescoping support frame.

8) A firefighting system for use on a firefighting truck as in claim 1, wherein said telescoping support frame is connected to a first pneumatic lifter.

9) A firefighting system for use on a firefighting truck as in claim 8, wherein said telescoping arm is connected to second pneumatic lifter.

10) A firefighting truck for use to fight fires, comprising:
a telescoping support frame;
a telescoping arm connected to said telescoping support frame;
a water pipe extension to extend said telescoping arm; and
a first spinning nozzle positioned at an end of said water pipe extension.

11) A firefighting truck for use to fight fires as in claim 10, wherein said firefighting truck includes a male adapter positioned at an end of said water pipe extension.

12) A firefighting truck for use to fight fires as in claim 11, wherein said firefighting truck includes a female adapter positioned at an end of said telescoping arm.

13) A firefighting truck for use to fight fires as in claim 14, wherein said female adapter is coupled to said male adapter.

14) A firefighting truck for use to fight fires as in claim 10, wherein said first spinning nozzle is positioned substantially perpendicular to said water pipe extension.

15) A firefighting truck for use to fight fires as in claim 10, wherein said firefighting truck includes a second spinning nozzle positioned opposed to said first spinning nozzle.

16) A firefighting truck for use to fight fires as in claim 10, wherein said firefighting truck includes a rotatable base connected to said telescoping support frame.

17) A firefighting truck for use to fight fires as in claim 10, wherein said telescoping support frame is connected to a first pneumatic lifter.

18) A firefighting truck for use to fight fires as in claim 17, wherein said telescoping arm is connected to second pneumatic lifter.
